(19) United States
(12) Patent Application Publication
(10) Pub. No.: US 2006/0050384 A1
(43) Pub. Date: Mar. 9, 2006

(54) System for displaying images in auto-stereoscopic format

(75) Inventor: John A. Agostinelli, Rochester, NY (US)

Correspondence Address: Pamela R. Crocker;Eastman Kodak Company, Patent Legal Staff, 343 State Street, Rochester, NY, 14650-2201, US

(73) Assignee: Eastman Kodak Company

(21) Appl. No.: 10/936,323

(22) Filed: Sep. 8, 2004

(51) Int. Cl. G02B 27/22

(52) U.S. Cl. 359/462; 359/464

(57) ABSTRACT

A system for displaying images in auto-stereoscopic format, the system includes an illumination source that produces light in at least two bands in synchronization with frame sequential stereo image data; a single spatial light modulator that is driven by the frame sequential stereo image data and that receives the two bands of light from the illumination source; and a real-time eye tracking device that monitors positions of eyes of a user so that viewing is not interrupted by movement of the eyes of the user; wherein the user views the two bands of light sequentially on only the single spatial display which projects a three-dimensional image to the viewer.

### FIELD OF THE INVENTION

The invention relates generally to the field of display systems that project images in auto-stereoscopic format and, more particularly, to such display systems having only a single display for projecting auto-stereoscopic format and/or having one or more fresnel lenses for projecting auto-stereoscopic format.

### BACKGROUND OF THE INVENTION

Currently, there is a need in the display industry for displaying images in three-dimensional format. One method for displaying three-dimensional images is to provide two images respectively onto two viewing screens, and a beam splitter merges the images provided from the two screens. This method is described European Patent Specification EP 0 602 934 B1 (hereinafter the '934 reference). In this patent specification, two light sources each include a plurality of individual light portions so that any portion of the light source may be illuminated at any time. The two screens respectively receive the light from the two light sources which images are viewed through a beam splitter. Lenses near the screens form images of the sources in a viewing region from which an observer perceives a three-dimensional image, when a stereo image pair is displayed upon the screens.

The '934 reference forms an auto-stereoscopic image whose optical position is near to the observer, and in fact, the optical position is located at the actual distance of the screens. This limits the useful volume of 3-D space, which may be comfortably viewed by the observer. U.S. Pat. No. 6,351,280 discloses an auto-stereoscopic display system that is based upon a liquid crystal display (LCD) system that incorporates two sub-arrays such that every other line of the LCD panel includes a micro-patterned half-wave retarder. The act of illuminating the LCD with a source comprised of two vertical bands of light, with each band configured in a manner such that they produce a light that is orthogonal linearly polarized, and by forming an image in space of the two bands, a stereoscopic image may be viewed from the position of the spatial image of the bands, when the two LCD sub-arrays are driven with proper stereo image pair data. A disadvantage of this approach includes the loss of inherent resolution of the LCD due to the spatial multiplexing of the sub arrays. Also, the optical position for accommodation is at the real image plane, that is, at the location of the LCD.

The technical literature also describes various lenses useful for displaying three-dimensional images. One such paper entitled An Auto-stereoscopic Display Providing Comfortable Viewing Conditions and A High Degree of Tele-presence by Klaus Hopf discloses several lenses useful for displaying three-dimensional images. This paper teaches that fresnel lenses are not useful in forming the distant virtual images for the purpose of displaying three-dimensional images.

Although the method disclosed by Hopf is satisfactory, the cost of providing two screens is costly and, in some instances, is undesirable because of the space required for two displays. Still further, it is desirable to use fresnel lenses due to the cost and ease of manufacturing.

Lenticular and barrier-screen auto-stereoscopic displays are very well known in the art. These have an inherent disadvantage in providing a lower spatial resolution than is available in the spatial light modulator that is the principal component of this type of auto-stereoscopic display.

Consequently, a need exists for displaying comfortably viewable auto-stereoscopic images onto only one screen and/or using fresnel lenses for displaying three-dimensional images. There also exists a need for a full resolution display for auto-stereoscopic images.

### SUMMARY OF THE INVENTION

The present invention is directed to overcoming one or more of the problems set forth above. Briefly summarized, according to one aspect of the present invention, the invention resides in a system for displaying images in auto-stereoscopic format, the system comprising (a) an illumination source that produces light in at least two bands in synchronization with frame sequential stereo image data; (b) a single spatial light modulator that is driven by the frame sequential stereo image data and that receives the two bands of light from the illumination source; and (c) a real-time eye tracking device that monitors positions of eyes of a user so that viewing is not interrupted by movement of the eyes of the user; wherein the user views the single spatial display which projects a three-dimensional image to the viewer when the single spatial display is illuminated sequentially by the two bands of light.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the advantage of displaying comfortably viewable images onto only one screen and/or using fresnel lenses in displaying three-dimensional images. It further provides the full spatial resolution of the spatial light modulator. Yet another advantage is robust viewer eye tracking and non-mechanical servo action to provide a large range of viewing positions.

### BRIEF DESCRIPTION OF THE DRAWINGS

FIG. 1 is an illustration of the system of the present invention; and

FIG. 2 is an illustration an alternative embodiment of the present invention.

### DETAILED DESCRIPTION OF THE INVENTION

Before discussing the present invention, it is instructive to note that spatial resolution is defined as the number of pixels per linear dimension of the spatial light modulator.

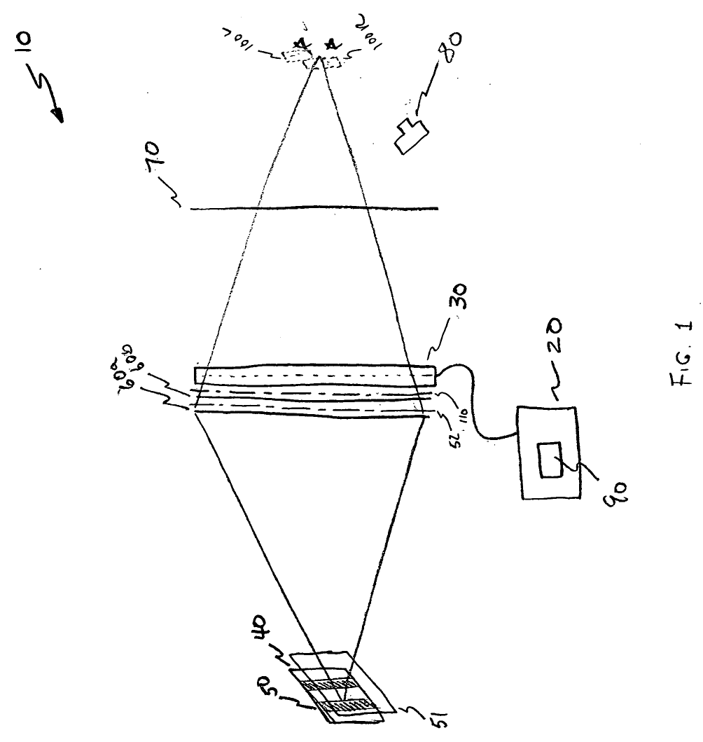

Referring to FIG. 1, there is shown an illustration of the auto-stereoscopic system 10 of the present invention. A computer 20 stores images that are transmitted to a liquid crystal display (LCD) 30. A light source 40 for visibly illuminating the LCD 30 includes a plurality of light emitting diodes (LEDs) or any other suitable lighting source, such as organic LEDs, fluorescent and the like, arranged in a panel array. The diodes are partitioned into a plurality of bands 50 in which each band 50 is lit individually so that the bands 50 may be illuminated in any predetermined manner. The panel array 40 projects light through two fresnel lenses 60a and 60b positioned back-to-back adjacent the LCD 30, and through the LCD 30, or any suitable transmissive spatial light modulator. Preferred spatial light modulators include active matrix liquid crystal display panels, particularly those with fast response. One such display is available through Samsung of South Korea that includes a response time of 8 ms. The fresnel lenses 60a and 60b form a real image in space of the bands 50. The real image in space of the bands 50 as used herein is referred to as viewing pupils 100L and 100R. The transmissive LCD 30 together with optical films 51 or 52 function as a weak diffuser and provide a smearing effect that reduces the imaging of discrete dots from, for example, an LED array which may form light source 40 at the position of the viewing pupils 100L and 100R.

It is instructive to note that, when two distinct bands 50 of the panel 40 are sequentially illuminated, two discrete images will be sequentially produced upon the LCD 30. Images selected for display are reproduced alternately (i.e., continuously and sequentially) for the left and right eyes of the viewer. Light produced by the lighting array panel 40 illuminates the LCD 30 coordinated with the plurality of images thus producing a stereoscopic image that may be viewed when a users eyes are positioned at the viewing pupils 100L and 100R. It is instructive to note that these images can be either coordinated still images or coordinated motion images. For example, the computer 20 will send an image to the LCD 30 that is intended only for the left eye. The panel array 40 will then be turned on in a manner that will illuminate only the left eye. The fresnel lenses 60a and 60b send the illumination through the LCD 30, and form an image of the selectively illuminated light source 40 at the left viewing pupil 100L. The viewers left eye, when placed at the location of the left viewing pupil 100L will see only the left eye image of a stereo pair. Upon the same being completed for the right eye only, the human visual system combines these two sequential images into a stereoscopic image. Each eye is presented with an image having the full spatial resolution inherent in the LCDs spatial light modulator. It is instructive to recall that when thinking of the operation of an old time View master, film was used to display mages that were offset from one another in accordance with the spacing of the human eyes. Illumination that was provided from a light source was passed through the offset frames of film, and was viewed as distant virtual images by action of the eyepieces. The film images include a stereo pair and so the viewer perceives a three-dimensional effect. The present invention provides illumination of information to the viewer's eyes alternately at a frame rate that is imperceptible to the human visual system thus producing a three-dimensional effect.

A third fresnel lens 70 is positioned on the opposite side of the LCD 30 from the other two fresnel lenses 60a and 60b for forming a distant virtual image of LCD 30 thus improving the depth volume of the viewer. In addition, the third fresnel lens 70 provides comfortable stereoscopic viewing. An eye tracker 80 is positioned in a location so that the users eye can be monitored in real time. The eye tracker 80 continuously locates the user's eyes so that, when the user moves their head, the system of the present invention can adjust to the changing position of the user's eyes by properly adjusting the illumination thus ensuring the coinciding of viewing pupils 100L and 100R with the user's eyes. More specifically, the bands 50 on the panel are adjusted to remain in registration with the user's eyes in accordance with the information received from the eye tracker 80. A processor 90 in the computer 20 coordinates the information from the eye tracker 80 to any corresponding change for which bands 50 are illuminated. Preferably, the eye tracker 80 is as disclosed in U.S. Pat. No. 6,459,446 issued on Oct. 1, 2002 to Philip Harman, which is herein incorporated by reference.

A diffusing element that can be activated electrically 110 switches from a transmissive mode to diffusing mode. Examples of such switchable elements include polymer dispersed liquid crystal (PDLC) elements that are well known in the art. Such elements are used as privacy glass and can be coated on plastic. Suitable PDLC element material is available from, for example SwitchLite Division of Pulp Studio, Inc. 3211 South La Cienega Blvd. Los Angeles, Calif. 90016. Other examples of switchable diffuser elements, e.g. smectic liquid crystal layers, and the like are also useful for the purposes of the invention. When in the transmissive state, the liquid crystal display produces auto-stereoscopic images viewable from pupils 100L and 100R, and when in the scattering state, the liquid crystal display produces ordinary two-dimensional images with ordinary LCD panel view ability.

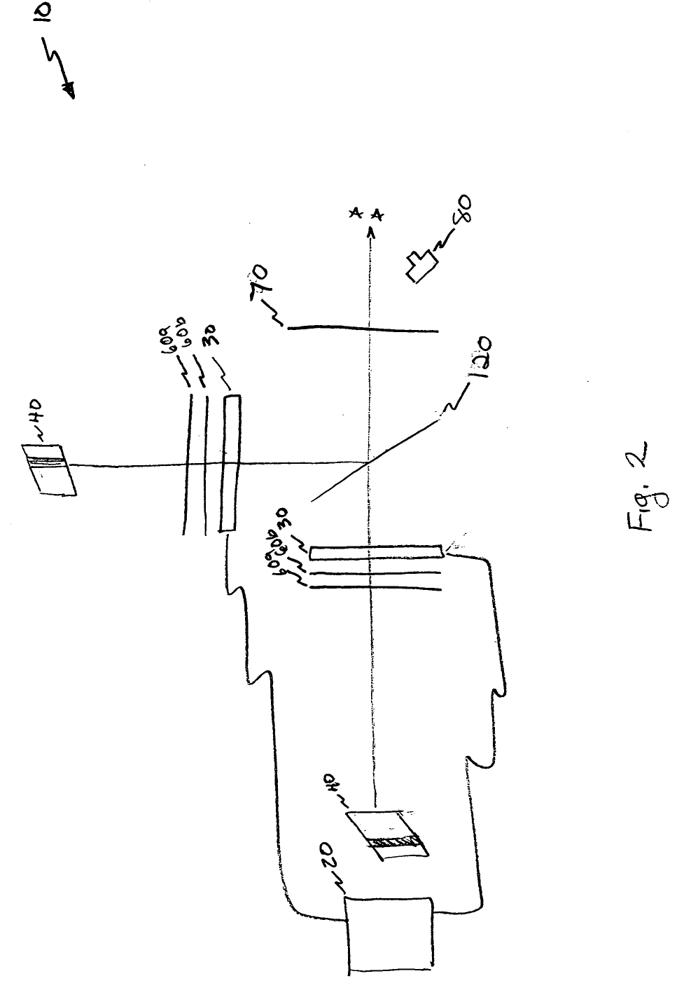

Referring to FIG. 2, there is shown an alternative embodiment of the present invention. The alternative embodiment includes two LCDs 30 positioned substantially ninety degrees from each other. A computer 20 stores and transmits frame information (images) to each individual LCD 30. Fresnel lenses 60a and 60b are positioned adjacent each LCD 30 for the purpose of forming viewing pupils 100L and 100R, as described hereinabove, from two light sources or panel arrays 40 respectively positioned adjacent the two LCDS 30 for projecting light through the LCDs 30. The light projected through each LCD 30 is directed onto a beam splitter 120 for coordinating the projection of the light passing through each LCD 30 in a manner in which the human visual system creates the perception of a three-dimensional image when the user's eyes are at the viewing pupils 100L and 100R.

For example, the computer 20 will send images individually to each of the LCD 30 in a manner such that one image from one LCD 30 is intended for the left eye and one image from the other LCD 30 is intended for the right eye only. The two panel arrays 40 will then be turned on in a manner that will provide from one panel array 40 the illumination for the left eye only, and from the other panel array 40 the illumination for the right eye only. The fresnel lenses 60a and 60b, positioned adjacent the two LCDs 30, forming viewing pupils 100L and 100R, send the right and left illumination through each LCD 30. The beam splitter 120 combines the left eye information and the right eye information that is displayed by the LCD panels; wherein the human visual system perceives combines these two images into a single stereoscopic image. As before, the third fresnel lens 70 produces distant virtual images thus enabling comfortable viewing of stereoscopic images over a large perceived volume of space.

As discussed above, an eye tracker 80 is positioned in a convenient location for facilitating locating the position of the user's eyes.

The invention has been described with reference to a preferred embodiment. However, it will be appreciated that variations and modifications can be effected by a person of ordinary skill in the art without departing from the scope of the invention.

### PARTS LIST

10 auto-stereoscopic system

20 computer

30 liquid crystal display (LCD)

40 light source/panel array

50 bands

51 optional film/diffuser

52 optional film/diffuser

60a fresnel lens

60b fresnel lens

70 third fresnel lens

80 eye tracker

90 processor

100L left viewing pupil

100R right viewing pupil

110 electrically activatable diffuser

120 beam splitter

What is claimed is:

1. A system for displaying images in auto-stereoscopic format, the system comprising:
(a) an illumination source that produces light in at least two spatial bands in synchronization with frame sequential stereo image data;
(b) a single spatial light modulator used at full spatial resolution that is driven by the frame sequential stereo image data and that receives light from the two bands from the illumination source;
(c) a first fresnel lens which forms an image of the two spatial bands of light that forms viewing pupils;
(d) a substantially real-time eye tracking device that monitors positions of eyes of a user; wherein positions of the spatial bands of light are controlled by the substantially real-time eye tracking device such that the viewing pupils track movement of the eyes of the user; and
(e) a second fresnel lens positioned between the spatial display and the user.

2. The system as in claim 1 further comprising an electrically activatable diffusing element that is switchable between a clear transmissive state and a scattering state such that, when in the scattering state, the spatial light modulator is diffusely illuminated and can be viewed from a continuum of viewing positions and, when the spatial light modulator is supplied with image data corresponding to a two-dimensional image, the system behaves as a two-dimensional display.

3. The system as in claim 1, wherein the spatial display is a liquid crystal display.

4. The system as in claim I further comprising at least two fresnel lenses positioned between the illumination source and the spatial display.

5. The system as in claim 1, wherein the illumination source is a light emitting diode panel arranged in a plurality of bands.

6. The system as in claim 1, wherein the first fresnel lens includes two fresnel lenses working in combination.

7. The system as in claim 1, wherein the illumination source is an array of light emitting diodes.

8. The system as in claim 7, wherein the light emitting diodes are either organic or inorganic.

9. The system as in claim 1, wherein the spatial light modulator is a fast-response active matrix liquid crystal display.

10. A system for displaying images in auto-stereoscopic format, the system comprising:
(a) two illumination sources that produce light in predetermined synchronization with each other;
(b) two spatial light modulators that respectively receive light from the two illumination sources in the predetermined synchronization and each spatial light modulator includes one or more fresnel lenses; and
(c) a beam splitter that receives light from both spatial light modulators so that the user perceives a three-dimensional image from viewing light projected from the beam splitter.

11. The system as in claim 10 further comprising a real-time eye-tracking device that monitors positions of eyes of a user so that viewing is not interrupted by movement of the eyes of the user.
